(19) United States
(12) Patent Application Publication
(10) Pub. No.: US 2026/0255227 A1
(43) Pub. Date: Aug. 27, 2026

(54) SUCCESSFUL PSCELL CHANGE OR ADDITION REPORT

(71) Applicant: Telefonaktiebolaget LM Ericsson (publ), Stockholm (SE)

(72) Inventors: Sakib Bin REDHWAN, Linköping (SE); Pradeepa RAMACHANDRA, Linköping (SE); Ali PARICHEHREHTEROUJENI, Svärtinge (SE); Tahmineh TORABIAN ESFAHANI, Sollentuna (SE); Marco BELLESCHI, Solna (SE); Julien MULLER, Rennes (FR)

(21) Appl. No.: 18/877,937

(22) PCT Filed: Aug. 7, 2023
(86) PCT No.: PCT/SE2023/050786

§ 371 Date: Dec. 20, 2024

Related U.S. Application Data
(60) Provisional application No. 63/395,964, filed on Aug. 8, 2022.

(51) Int. Cl. H04W 36/00

(52) U.S. Cl. CPC H04W 36/0058; H04W 36/00835

(57) ABSTRACT

A method performed by a user equipment (UE) includes receiving a successful primary secondary cell group cell (PSCell) report configuration containing conditions of a successful PSCell report. Based on satisfying a condition defined by the successful PSCell report configuration during the PSCell change procedure, the method stores information in a successful PSCell report indicating which of the plurality of network nodes initiated the PSCell change procedure.

### TECHNICAL FIELD

The present disclosure relates generally to communications, and more particularly to communication methods and related devices and nodes supporting wireless communications.

### BACKGROUND

Multi-radio dual connectivity (MR-DC) is a technique where multiple Rx/Tx capable UE may be configured to utilize resources provided by two different nodes connected via non-ideal backhaul. One node act as the master node (MN) and another node acts as the secondary node (SN). The MN and SN are connected via a network interface and at least the MN is connected to the core network. Detailed architectural description of MR-DC can be found in TS 37.340[1].

A group of serving cells associated with the Master node is called Master cell group. The master cell group includes primary cell (PCell) and optionally one or more Secondary Cells (SCell).

A group of serving cells associated with the Secondary node is called Secondary cell Group, which can include a Primary secondary cell (PSCell) and optionally one or more SCells. PCell and PSCells together are expressed as SpCell.

A conditional PSCell change (CPC) is defined as a PSCell change that is executed by the UE when the execution condition(s) for a PSCell change is met. The UE starts evaluating the execution condition(s) upon receiving the CPC configuration and stops evaluating the execution condition(s) once PSCell change is triggered. Intra-SN CPC without MN involvement, inter-SN CPC initiated by either MN or SN are supported.

Similarly, conditional PSCell addition (CPA) is supported initiated by MN only.

Successful handover report (SHR) has been standardized as part of 3GPP Rel 17TS e.g., see RRC spec 38.331(V 17.0.0 ). The main purpose of the successful handover (HO) report is to enable the network nodes to deduce sub-optimal performance of the underlaying procedures executed during the HO procedure.

The network node upon being interested in SHR, can configure the user equipment (UE) to report the SHR after successful execution of a HO, if at least one of the SHR triggering conditions/thresholds is met. The SHR triggering thresholds are defined as following:
Whether the T304 timer value was above a certain threshold at the time of successful HO execution (thresholdPercentageT304)
Whether the T310 timer value was above a certain threshold at the time of successful HO execution (thresholdPercentage T310)
Whether the T312 timer value was above a certain threshold at the time of successful HO execution (thresholdPercentage T312)
Whether the UE experienced radio link failure (RLF) at source node while performing a dual active protocol stack (DAPS) HO (sourceDAPS-FailureReporting).

When storing the successful handover report, the UE may include various information to aid the network to optimize the handover, such as measurements of the neighbouring cells, the fulfilled condition that triggered the successful handover report (e.g. threshold on T310 exceeded, specific RLF issue in the source while doing DAPS HO), etc.

The SHR can be configured by a certain serving cell, and when triggering conditions for SHR logging are fulfilled, the UE stores this information until the network (NW) requests it. In particular, the UE may indicate availability of SHR information in certain radio resource control (RRC) message, such as RRCReconfigurationComplete, RRCReestablishmentComplete, RRCSetupComplete, RRCResumeComplete, and the network may request such information via the UEInformationRequest message, upon which the UE transmits the stored SHR in the UEInformationResponse message.

Upon reception of a Successful HO Report, the receiving node is able to analyze whether its mobility configuration needs adjustment. Such adjustments may result in changes of mobility configurations, such as changes of radio link monitoring (RLM) configurations or changes of mobility thresholds between the source and the target. In addition, target NG RAN node, in the performed handover, may further optimize the dedicated random access channel (RACH)-beam resources based on the beam measurements reported upon successful handovers.

In 3GPP Rel. 18, the above functionalities will be extended to cover the case of Successful PSCell change/addition (SPR).

### SUMMARY OF THE INVENTION

Some embodiments disclosed herein are directed to a method performed by a user equipment (UE). The method includes receiving a successful primary secondary cell group cell, PSCell, report configuration containing conditions of a successful PSCell report. The method further includes, based on satisfying a condition defined by the successful PSCell report configuration during the PSCell change procedure, storing information in a successful PSCell report indicating which of the plurality of network nodes initiated the PSCell change procedure.

Some other embodiments are directed to a method performed by a network node among a plurality of network nodes. The method includes sending to a UE a successful PSCell report configuration containing conditions for a successful PSCell report.

Some other embodiments are directed to a corresponding UE which is adapted to receive a successful PSCell report configuration containing conditions of a successful PSCell report. The user equipment is further adapted to, based on satisfying a condition defined by the successful PSCell report configuration during the PSCell change procedure, store information in a successful PSCell report indicating which of the plurality of network nodes initiated the PSCell change procedure.

Some other embodiments are directed to a corresponding UE including at least one processor and at least one memory storing instructions. The instructions executable by the at least one processor to perform operations including receive a successful PSCell report configuration containing conditions of a successful PSCell report. The instructions executable by the at least one processor to further perform operations including, based on satisfying a condition defined by the successful PSCell report configuration during the PSCell change procedure, store information in a successful PSCell report indicating which of the plurality of network nodes initiated the PSCell change procedure.

Some other embodiments are directed to a computer program product including a non-transitory computer readable medium storing instructions executable by at least one processor of a UE to perform operations including to receive a successful PSCell report configuration containing conditions of a successful PSCell report. The instructions executable by the at least one processor of the UE to further perform operations including, based on satisfying a condition defined by the successful PSCell report configuration during the PSCell change procedure, store information in a successful PSCell report indicating which of the plurality of network nodes initiated the PSCell change procedure.

Some other embodiments are directed to a corresponding network node among a plurality of network nodes. The network node adapted to send to a UE a successful PSCell report configuration containing conditions for a successful PSCell report.

Some other embodiments are directed to a network node among a plurality of network nodes comprising at least one processor and at least one memory storing instructions executable by the at least one processor to perform operations to send to a user equipment, UE, a successful PSCell report configuration containing conditions for a successful PSCell report.

Some other embodiments are directed to a computer program product comprising a non-transitory computer readable medium storing instructions executable by at least one processor of a network node to perform operations including to send to a UE a successful PSCell report configuration containing conditions for a successful PSCell report.

Some potential advantages of these embodiments includes that a network node of a plurality of network nodes originating/initiating the PSCell change procedure that led to a successful PSCell report is identified in a quick and efficient manner by including an indication of which of a plurality of network nodes initiated the PSCell change procedure. By including an indication of which of the plurality of network nodes initiated the PSCell change procedure, the required processing time and power to determine which network node initiated the PSCell change procedure, or where the PSCell change procedure originated from, is decreased. Other potential advantages of these embodiments include saving processing time, processing power, and storage space by storing measurements related to the PSCell change procedure and information in the successful PSCell report in certain circumstances. For example, storing based on satisfying a condition defined by the successful PSCell report configuration during the PSCell change procedure.

Other methods, network nodes, and related devices according to embodiments will be or become apparent to one with skill in the art upon review of the following drawings and detailed description. It is intended that all such additional methods, network nodes, and related devices be included within this description and protected by the accompanying claims.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a communication system in accordance with some embodiments;

FIG. 2 is a flow chart illustrating operations of a UE according to some embodiments of inventive concepts;

FIG. 3 is a flow chart illustrating operations of a network node according to some embodiments of inventive concepts;

FIG. 4 is a block diagram of a communication system in accordance with some embodiments;

FIG. 5 is a block diagram of a user equipment in accordance with some embodiments;

FIG. 6 is a block diagram of a network node in accordance with some embodiments;

FIG. 7 is a block diagram of a host computer communicating with a user equipment in accordance with some embodiments;

FIG. 8 is a block diagram of a virtualization environment in accordance with some embodiments; and

FIG. 9 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art., in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

In current Rel 18 SON/MDT WID document (RP-221825), it is identified that there is a need for studying successful PSCell report collection and reporting to the network. However, current operations to enable the UE to collect/log successful PSCell change/addition information and measurement and reporting to the network are not standardized. Moreover, in current 3GPP RRC TS specification 38.331 (Version 17.1.0), the UE is un-aware of the initiator of the PSCell change procedure (MN initiated SN change or SN initiated SN change) and such information is not stored in the network. Thus, upon receiving the successful PSCell report in the network, it is not possible to identify the node (MN or SN) responsible for RRC configurations that triggered the UE to generate the successful PSCell report. Not knowing the initiator node of the PSCell change causes ambiguity in analyzing the report and finding the root cause of the issues that caused sub-optimal performance at PSCell change procedures.

In accordance with various embodiments of the present disclosure, the UE is configured to include the originator of the PSCell change procedure into the Successful PSCell Report. Additionally, the network node can be configured to inform the UE about the originator of the PSCell change procedure when configuring the UE with a successful PSCell report configuration.

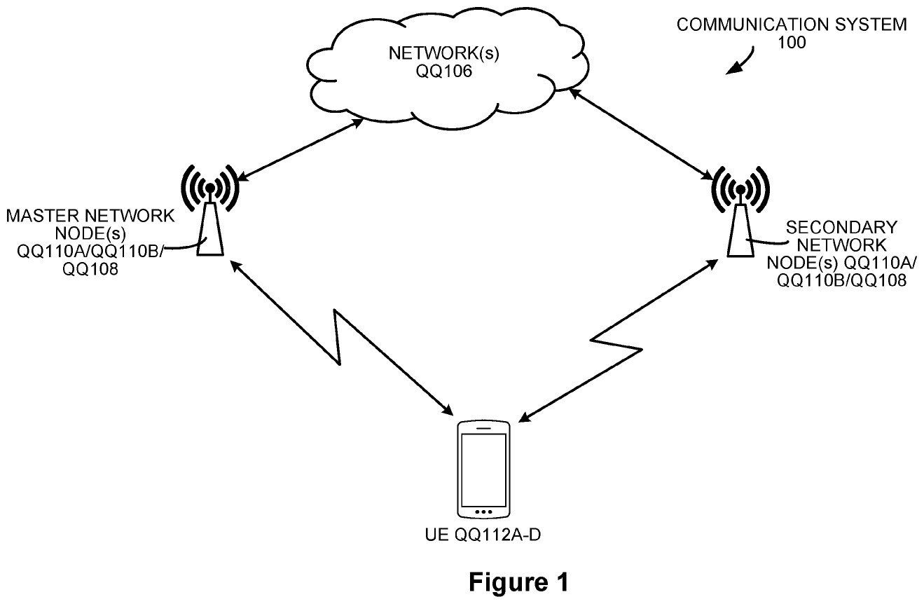

FIG. 1 illustrates a communication system 100 that includes a master network node QQ110A/QQ110B/QQ108 and a secondary network node QQ110A/QQ110B/QQ108 that can communicate with each other through network(s) QQ106 providing backhaul communications. The master network node QQ110A/QQ110B/QQ108 and secondary network node QQ110A/QQ110B/QQ108 can communicate with a UE QQ112A-D using multi-radio dual connectivity.

Various embodiments of the present disclosure are directed to operations performed by a User equipment (UE) QQ112A-D to receive configurations from at least one network nodes (RAN nodes) (e.g., MN QQ110A/QQ110B/QQ108 and/or SN QQ110A/QQ110B/QQ108) to evaluate Successful PSCell change or addition reporting conditions, stores configured parameters and the measurements in a Successful PSCell Report and transmit the report to the network QQ160 and, more particularly, to one of the network nodes QQ110A/QQ110B/QQ108. The operations by the UE include:
Operation (1): Receiving a successful PSCell report configuration from the network node. An indication in the configuration indicating whether the PSCell change procedures are initiated by the MN QQ110A/QQ110B/QQ108 OR THE SN QQ110A/QQ110B/QQ108.
Operation (2): Evaluating the conditions as configured in the successful PSCell report configuration during a PSCell change procedure and, upon execution of the PSCell change procedure. Storing/logging information and measurements regarding the executed PSCell change in the successful PSCell report performed in accordance with the configuration. Including information regarding PSCell change initiator in the successful PSCell change report.
Operation (3): Reporting the availability of successful PSCell report to the network node QQ106.
Operation (4): Reporting the successful PSCell report to the network node QQ106.

Some other embodiments are directed to operations by the network node to configure the UE QQ112A-D with successful PSCell report configuration and including indication regarding the originator of the PSCell change procedure.

In one embodiment, if the Successful PSCell report configuration is configured by the target SN, the operations include:

The source master network node (MN) provides the target Secondary network node (SN) an indicator to identify the originator/initiator of the PSCell change procedure. In one embodiment, this indicator is included in an SN Addition Request message.

The target network node (SN) includes this indicator in the configuration sent to the UE QQ112A-D.

In one embodiment, if the Successful PSCell report configuration is configured by the MN, e.g. in case of MN initiated PSCell change, the operations include:

The master network node (MN) includes an indicator to identify the originator/initiator of the PSCell change procedure (here the MN) in the configuration sent to the UE QQ112A-D.

In one embodiment, if the Successful PSCell report configuration is configured by the source SN, e.g. in case of SN initiated PSCell change, the operations include:
A) (Optional) The source secondary network node (SN) provides the source master network node (MN) an indicator to identify the originator/initiator of the PSCell change procedure, which is source MN in this case;
B) The source master network node (MN) includes this indicator in the configuration sent to the UE. In another embodiment, if the source MN received from the source SN an SPR configuration for PSCell change it appends the indicator to identify the originator/initiator of the PSCell change procedure; and/or
C) In one embodiment, the source SN includes this indicator in the configuration sent to the UE via SRB3.

Upon executing any of the above embodiments, the following operations for a network node (where the network node can refer to source MN, source SN, target SN or a different node) are applied:
Operation (1): The target network node (SN) or any other network node receiving the successful PSCell report from the UE.
Operation (2): Distributing the successful PSCell report (201) to other network nodes based on the indicator.

Potential advantages of one or more embodiments of the present disclosure can include to identify the network node (MN or SN) originating/initiating the PSCell change procedure that led to a successful PSCell report.

Throughout the present disclosure, the terms network nodes and RAN nodes may be used interchangeably. Furthermore, the term MN and SN can be different from UE perspective, i.e., same network node can act as MN and SN simultaneously for different UEs. The Successful PSCell Report indicates a report from the UE in response to Successful PSCell report configuration and may have a different name.

Corresponding operations by a UE are now described in further detail below.

Herein, operations are disclosed where a UE receives successful PSCell report configuration(s) from the network nodes (e.g., RAN nodes) to evaluate Successful PSCell change or addition reporting conditions, stores information and measurements based on the received configuration in a Successful PSCell Report, and transmits the report to the network. The operations by the UE include:
Operation (1): Receiving a successful PSCell report configuration from the network node.

UE receives at least one successful PSCell report configuration from the network node containing different triggering options/conditions of the successful PSCell report. The configuration(s) further include indication regarding the initiator of the PSCell change procedure.

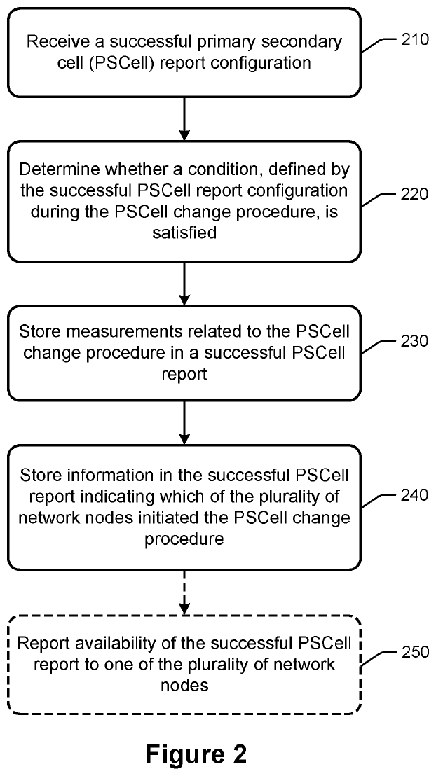

FIG. 2 illustrates a flowchart of example operations that can be performed by a UE in accordance with some embodiments.

Referring to FIG. 2, in block 210, the UE receives a successful primary secondary cell (PSCell) report configuration containing conditions of a successful PSCell report and indicating which of a plurality of network nodes initiated a PSCell change procedure. In block 220, the UE may determine whether a condition, defined by the successful PSCell report configuration during the PSCell change procedure, is satisfied.

In some embodiments, the determination of whether a condition, defined by the successful PSCell report configuration, is satisfied is determined elsewhere (other than at the UE). For example, at a network node. In these embodiments, an indication of whether the condition is satisfied may then be sent to, and received by, the UE.

Accordingly, the operations of block 210 for determining whether a condition is satisfied may be optional for the UE.

Based on satisfying a condition defined by the successful PSCell report configuration during the PSCell change procedure, in block 230, the UE stores measurements related to the PSCell change procedure in a successful PSCell report. The measurements are performed according to the successful PSCell report configuration.

Additionally, based on satisfying the condition, in block 240, the UE stores information in the successful PSCell report indicating which of the plurality of network nodes initiated the PSCell change procedure.

Optionally, in block 250, the UE may report availability of the successful PSCell report to one of the plurality of network nodes.

In one embodiment, the indication is a flag indicating whether the PSCell change procedure is originated by MN or SN. In a non-limiting example, the value 0 indicates the PSCell change procedure is initiated by MN and the value 1 indicates the PSCell change procedure is initiated by SN.

An example corresponding operation by the UE can include the storing information in the successful PSCell report indicating which of the plurality of network nodes initiated the PSCell change procedure. This includes storing a flag in the successful PSCell report indicating whether the PSCell change procedure was initiated by a master node, MN, or a secondary node, SN, among the plurality of network nodes.

In another embodiment, the presence of the indication indicates the PSCell change is originated by MN. The absence of the indication indicates the PSCell change is originated by SN.

An example corresponding operation by the UE can include storing a flag in the successful PSCell report, based on the PSCell change procedure being initiated by a defined one of a master node, MN, and a secondary node, SN, among the plurality of network nodes. Where the presence of the flag in the successful PSCell report indicates the defined one of the MN and SN initiated the PSCell change procedure.

Another example corresponding operation by the UE can include not storing the flag in the successful PSCell report based on the PSCell change procedure being initiated by the other one of the MN and the SN. Where the absence of the flag in the successful PSCell report indicates the other one of the MN and SN initiated the PSCell change procedure.
Operation (2): Evaluating the PSCell report triggering conditions during a PSCell change procedure.

UE evaluates the successful PSCell triggering conditions, received as part of the last applied RRC Reconfiguration including the reconfiguration WithSync, during a PSCell change procedure and upon meeting/fulfilling the successful PSCell report triggering conditions, logs necessary information in the successful PSCell report. Non-limiting examples of the logged information include:
A) Source PSCell information, e.g. source PSCell CGI (Cell Global Identity);
B) Target PSCell information, e.g. target PSCell CGI; and/or
C) Source PCell information, e.g. source PCell CGI, where the source PCell is the PCell at the moment of executing the PSCell change/addition procedure.

An example corresponding operation by the UE can include, based on satisfying the condition, storing in the successful PSCell report at least one of: source PSCell information; target PSCell information; and source primary cell, PCell, information at a time of the PSCell change procedure.

Furthermore, UE logs the PSCell change initiator node indication in the report, i.e. MN or SN.

In one embodiment, UE explicitly includes the received indication to the report.

In another embodiment, UE does not explicitly include the indication in the report. In one embodiment, the UE includes the PCell information (e.g., PCell Identity) mentioned above only if the PSCell change procedure was initiated by the MN.

Absence of the PCell information is an indirect indication that the procedure was initiated by the SN.

An example corresponding operation by the UE can include the storing of the information in the successful PSCell report indicating which of the plurality of network nodes initiated the PSCell change procedure, being performed responsive to determining the PSCell change procedure was initiated by a master node (MN).

Another example corresponding operation by the UE can include where the storing of the information in the successful PSCell report indicating which of the plurality of network nodes initiated the PSCell change procedure, includes: storing the source PSCell information and the target PSCell information without storing the source PCell information in the successful PSCell report, responsive to determining the PSCell change procedure was initiated by a master node, MN.

In another embodiment, the UE includes the source PCell information and source PSCell information, both in case the PSCell change procedure was initiated by the MN or SN. In one embodiment, the UE does not include the source PSCell information only in case of PSCell addition procedure. In this latter case if the SHR only contains the target PSCell information and source PCell information, the network will determine that the SHR was associated to a PSCell addition procedure.

An example corresponding operation by the UE can include where the storing of the information in the successful PSCell report indicating which of the plurality of network nodes initiated the PSCell change procedure, includes: storing the source PSCell information and the target PSCell information without storing the source PCell information in the successful PSCell report, responsive to determining the PSCell change procedure was initiated by a master node, MN, or a secondary node, SN.

In a different embodiment, the UE includes the source PSCell information only if it is available. Hence, during first PSCell addition procedure, the source PSCell information is unavailable.

In another embodiment, the UE added the successful PSCell report in a list of successful PSCell reports.
Operation (3): Reporting the availability of PSCellreport to the network.

UE reports the availability of the successful PSCell change report to the network.

In one embodiment, UE sends the successful PScell report availability indication to the serving MN after PSCell change procedure.

In another embodiment, UE sends the successful PSCell report availability indication to the target SN.

In yet another embodiment, UE sends the successful PSCell report availability indication to a third network SN, different from the target SN and serving MN.

In an independent embodiment, UE includes an explicit capability indication to the target MN, target SN or a third network that it is capable of reporting successful PSCell report indicating the ability to report via successful PSCell report or other RRC messages e.g., RRCSetup complete, RRC Resume complete etc. The capability could be further separated in terms of the RAT type (e.g., the capability indication related to EUTRA or NR MCG).
Operation (4): Reporting the successful PSCell report to the network.

UE reports the successful PSCell report to the network upon receiving a report request from the network. Current standardized UE information request and response mechanism/procedure may be used in this regards.

Corresponding operations by a network node are now described in further detail below.

Other embodiments of the present disclosure are directed to operations by a network node to configure the UE with successful PSCell report configuration and including indication regarding the originator/initiator of the PSCell change procedure.

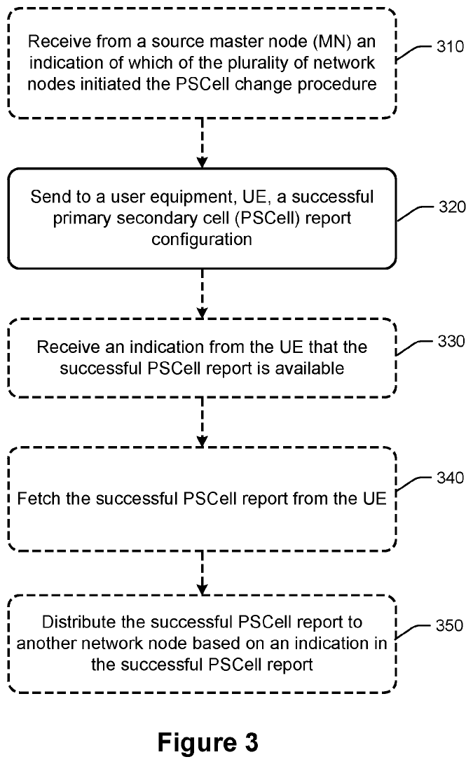

FIG. 3 illustrates a flowchart of example operations that can be performed by a network node in accordance with some embodiments. Referring to FIG. 3, in block 320 the network node sends to a UE a successful primary secondary cell (PSCell) report configuration containing conditions for a successful PSCell report and indicating which of the plurality of network nodes initiated a PSCell change procedure.

In a further embodiment, where the network node is a target secondary node (SN), the network node (in block 310) can optionally receive from a source master node, MN, an indication of which of the plurality of network nodes initiated the PSCell change procedure. Additionally, the network node can generate the successful PSCell report configuration to include the indication of which of the plurality of network nodes initiated the PSCell change procedure.

Optionally, in some embodiments, the network node (in block 330) can receive an indication from the UE that the successful PSCell report is available.

Optionally, in some embodiments, the network node (in block 340) can fetch the successful PSCell report from the UE.

Optionally, in some embodiments, the network node (in block 350) can distribute the successful PSCell report to another network node based on an indication in the successful PSCell report of which of the plurality of network nodes initiated the PSCell change procedure. Additionally, or alternatively, the successful PSCell report can include PCell information, and the other network node is selected to receive distribution of the successful PSCell report based on the PCell information.

Further related operations by the network node can include the following five numbered operations (1)-(5) explained below:
Operation (1): The source Master network node (MN) provides the target Secondary network node (SN) an indicator to identify the originator of the PSCell change procedure.

In one embodiment, the indicator is a flag indicating whether the PSCell change is originated/initiated by MN or SN. For example the value 0 indicates the PSCell change procedure is initiated by MN and the value 1 indicates the PSCell change procedure is initiated by SN.

For example, the indication received from the source MN (in block 310) includes a flag indicating whether the PSCell change procedure was initiated by a MN or a secondary node, SN, among the plurality of network nodes.

In another embodiment, the presence of the indication indicates the PSCell change is originated by MN. The absence of the indication indicates the PSCell change is originated by SN.

In some embodiments, the network node can perform operations including determining the PSCell change procedure was initiated by a defined one of a master node, MN, and a secondary node, SN, among the plurality of network nodes. The determination can be based on receiving a flag from a source master node, MN, and determining the PSCell change procedure was initiated by the other one of the MN and the SN based on absence of receiving the flag from the source MN.

In yet another embodiment, the indication is included in a SN Addition Request. For example, the indication of which of the plurality of network nodes initiated the PSCell change procedure may be received, by the network node, from the source MN in a source node, SN, addition request message.
Operation (2) The target network node (SN) includes this indicator (301) in the configuration (101) sent to the UE. Accordingly, as described above, the network node operates to send to the UE a successful PSCell report configuration containing conditions for a successful PSCell report and indicating which of the plurality of network nodes initiated the PSCell change procedure.

The target network node (SN) includes the indication in the RRC configuration including reconfiguration with sync sent to the UE.

In one embodiment, for intra-SN PSCell change procedure, the indication is included by the SN indicating SN to be the initiator of the procedure.

In an alternative embodiment, if the Successful PSCell report configuration is configured by the source MN, e.g. in case of MN initiated PSCell change, the operations include: the source master network node (MN) includes this indicator in the configuration sent to the UE.

In one embodiment, if the Successful PSCell report configuration is configured by the source SN, e.g. in case of SN initiated PSCell change, the operations further include:
A) (Optional) The source secondary network node (SN) provides the source master network node (MN) an indicator to identify the originator/initiator of the PSCell change procedure, which is source MN in this case; and/or
B) The source master network node (MN) includes this indicator in the configuration sent to the UE. In another embodiment, if the source MN received from the source SN an SHR configuration for PSCell change it appends the indicator to identify the originator/initiator of the PSCell change procedure (which is source MN or the source SN in this case).

For example, where the network node is a source master network node (MN), the network node may generate the successful PSCell report configuration to include an indicator identifying the source master node, MN, that initiated the PSCell change procedure. Additionally, when the successful PSCell report configuration is configured by a source secondary node (SN), the source MN receives from the source SN an indication that the source SN initiated the PSCell change procedure.

Operation (3) The target network node (SN) or any other network node receiving indication about availability of successful PSCell report from the UE.

The target network node (SN) or any other network node receives an indication from the UE regarding availability of the Successful PSCell report. A corresponding operation by the network node includes receiving an indication from the UE that the successful PSCell report is available.

Operation (4) The target network node (SN) or any other network node receiving the successful PSCell report from the UE.

The target network node (SN) fetches the PSCell report from the UE. It can be performed using standardized UE information request and response procedure. A corresponding operation by the network node includes fetching the successful PSCell report from the UE.
Operation (5) Distributing the successful PSCell report to other network nodes based on the indicator.

The target network node (SN) or any other network node distributes the PSCell report to other network nodes based on the initiator indicator, indicated in the successful PSCell report. A corresponding operation by the network node includes distributing the successful PSCell report to another network node based on an indication in the successful PSCell report of which of the plurality of network nodes initiated the PSCell change procedure.

In one embodiment, if the UE includes PCell information, it is an implicit indicator that the PSCell change procedure was initiated by the MN and the target SN forwards it to the source MN. Absence of such PCell information refers to the PSCell change procedure being initiated by SN and the target SN provides this information to source SN only.

In another embodiment, if the UE includes explicit indicator regarding the initiator of the PSCell change procedure, the target SN sends the report to the initiating node only. Hence, the target SN forwards the report to source MN or to source SN.

In yet another embodiment, if the UE includes explicit indicator regarding the initiator of the PSCell change procedure, regardless of the initiator, the target SN forwards the report to only source MN.

In a sub-embodiment, the source MN forwards the report to the source SN.

In some instances, the node receiving the successful PScell report from the UE is neither MN nor SN (i.e., a third network node). In such instances, the node receiving the successful PSCell report either forwards the report to the target SN of the PSCell change, to the initiator of the PSCell change procedure, or even to both of the nodes.

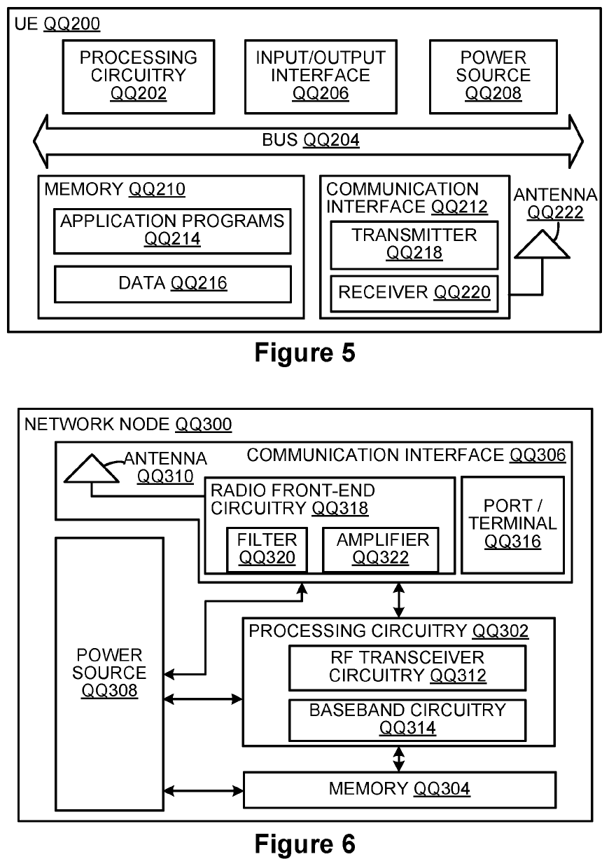

Operations of the communication device QQ200 (implemented using the structure of the block diagram of FIG. 5) have been discussed above with reference to the flow chart of FIG. 2 according to some embodiments of inventive concepts. For example, modules may be stored in memory QQ210 of FIG. 5, and these modules may provide instructions so that when the instructions of a module are executed by respective communication device processing circuitry QQ202, processing circuitry QQ202 performs respective operations of the flow chart.

Various operations from the flow chart of FIG. 2 may be optional with respect to some embodiments of communication devices and related methods. For example, one or more of operations of blocks 230 and 250 of FIG. 2 may be optional.

Operations of the RAN node QQ300 (implemented using the structure of FIG. 6) have been discussed above with reference to the flow chart of FIG. 3 according to some embodiments of inventive concepts. For example, modules may be stored in memory QQ304 of FIG. 6, and these modules may provide instructions so that when the instructions of a module are executed by respective RAN node processing circuitry QQ220, RAN node QQ300 performs respective operations of the flow chart.

Various operations from the flow chart of FIG. 3 may be optional with respect to some embodiments of RAN nodes and related methods. For example, one or more of operations of blocks 310, 330, 340, and 350 of FIG. 3 may be optional.

Operations of the Core Network CN node QQ300 (implemented using the structure of FIG. 6) have been discussed above with reference to the flow chart of FIG. 3 according to some embodiments of inventive concepts. For example, modules may be stored in memory QQ304 of FIG. 6, and these modules may provide instructions so that when the instructions of a module are executed by respective CN node processing circuitry QQ302, CN node QQ300 performs respective operations of the flow chart.

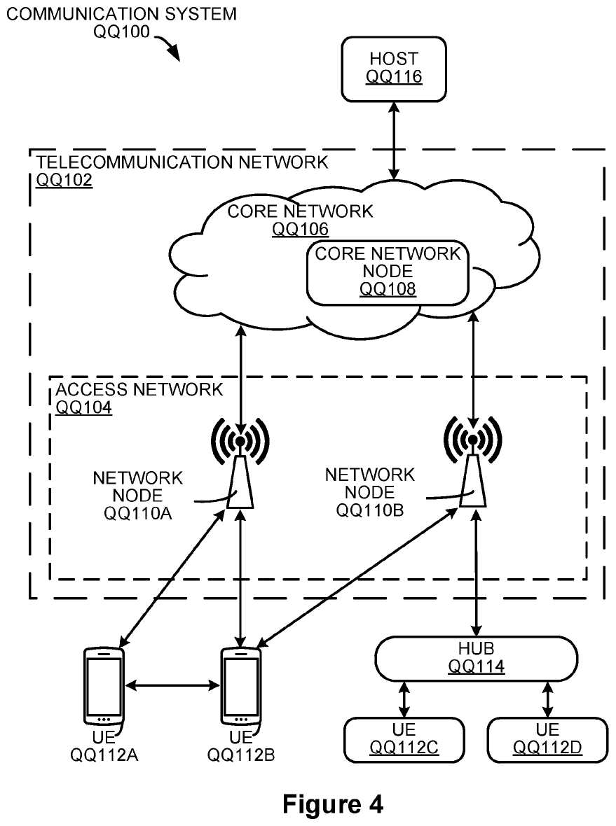

FIG. 4 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS);

Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 5 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs)

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M 2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 6 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

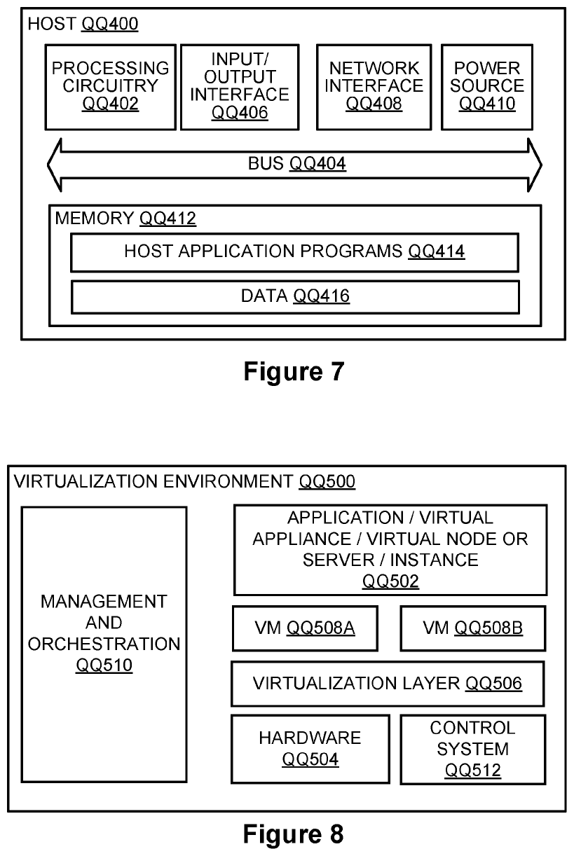

FIG. 7 is a block diagram of a host QQ400, which may be an embodiment of the host QQ116 of FIG. 4, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 5 and 6, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas.

Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

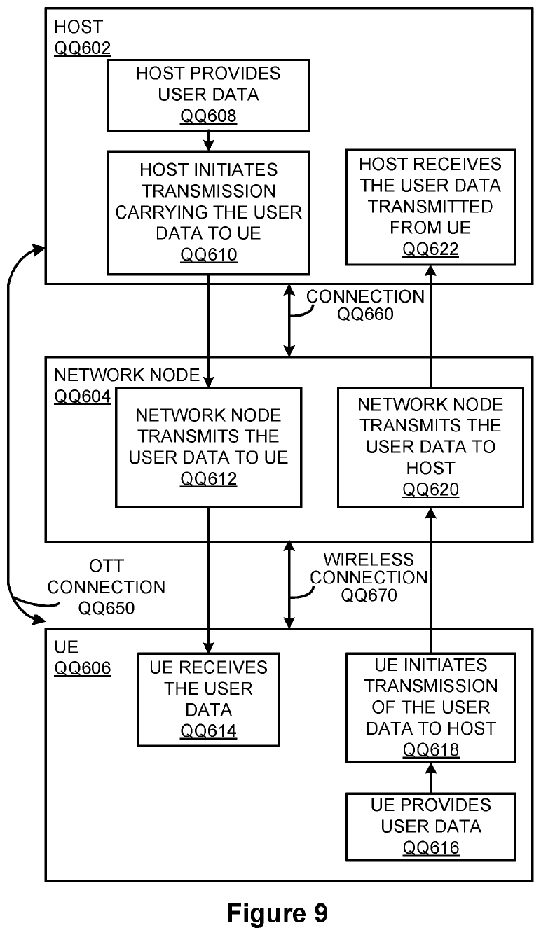

FIG. 9 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 4 and/or UE QQ200 of FIG. 5), network node (such as network node QQ110a of FIG. 4 and/or network node QQ300 of FIG. 6), and host (such as host QQ116 of FIG. 4 and/or host QQ400 of FIG. 7) discussed in the preceding paragraphs will now be described with reference to FIG. 9.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 4) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc. ; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally. p1 1. A method performed by a user equipment, UE, comprising:
receiving (210) a successful primary secondary cell, PSCell, report configuration containing conditions of a successful PSCell report and indicating which of a plurality of network nodes initiated a PSCell change procedure; and
based on (220) satisfying a condition defined by the successful PSCell report configuration during the PSCell change procedure,
storing (230) measurements related to the PSCell change procedure in a successful PSCell report, wherein the measurements are performed according to the successful PSCell report configuration, and
storing (240) information in the successful PSCell report indicating which of the plurality of network nodes initiated the PSCell change procedure.
2. The method of Embodiment 1 further comprising:
reporting (250) availability of the successful PSCell report to one of the plurality of network nodes.
3. The method of any of Embodiments 1 to 2, wherein the storing (240) of the information in the successful PSCell report indicating which of the plurality of network nodes initiated the PSCell change procedure, is performed responsive to determining the PSCell change procedure was initiated by a master node, MN.
4. The method of any of Embodiments 1 to 2, wherein the storing (240) information in the successful PSCell report indicating which of the plurality of network nodes initiated the PSCell change procedure, comprises storing a flag in the successful PSCell report indicating whether the PSCell change procedure was initiated by a master node, MN, or a secondary node, SN, among the plurality of network nodes.
5. The method of any of Embodiments 1 to 4, further comprising:
based on the PSCell change procedure being initiated by a defined one of a master node, MN, and a secondary node, SN, among the plurality of network nodes, storing a flag in the successful PSCell report, wherein presence of the flag in the successful PSCell report indicates the defined one of the MN and SN initiated the PSCell change procedure; and
based on the PSCell change procedure being initiated by the other one of the MN and the SN, not storing the flag in the successful PSCell report, wherein absence of the flag in the successful PSCell report indicates the other one of the MN and SN initiated the PSCell change procedure.
6. The method of any of Embodiments 1 to 5, further comprising based on satisfying the condition:
storing (240) in the successful PSCell report at least one of: source PSCell information; target PSCell information; and source primary cell, PCell, information at a time of the PSCell change procedure.
7. The method of Embodiment 6, wherein the storing (240) of the information in the successful PSCell report indicating which of the plurality of network nodes initiated the PSCell change procedure, comprises:
responsive to determining the PSCell change procedure was initiated by a master node, MN, storing the source PSCell information and the target PSCell information without storing the source PCell information in the successful PSCell report.
8. The method of Embodiment 6, wherein the storing (240) of the information in the successful PSCell report indicating which of the plurality of network nodes initiated the PSCell change procedure, comprises:
responsive to determining the PSCell change procedure was initiated by a master node, MN, or a secondary node, SN, storing the source PSCell information and the target PSCell information without storing the source PCell information in the successful PSCell report.
9. A method performed by a network node among a plurality of network nodes, the method comprising:
sending (320) to a user equipment, UE, a successful primary secondary cell, PSCell, report configuration containing conditions for a successful PSCell report and indicating which of the plurality of network nodes initiated a PSCell change procedure.
10. The method of Embodiment 9, wherein the network node is a target secondary node, SN, and the method further comprises:
receiving (310) from a source master node, MN, an indication of which of the plurality of network nodes initiated the PSCell change procedure; and
generating (320) the successful PSCell report configuration to include the indication of which of the plurality of network nodes initiated the PSCell change procedure.
11. The method of Embodiment 10, wherein the indication received (310) from the source MN comprises a flag indicating whether the PSCell change procedure was initiated by a MN or a secondary node, SN, among the plurality of network nodes.
12. The method of any of Embodiments 9 to 11, further comprising determining the PSCell change procedure was initiated by a defined one of a master node, MN, and a secondary node, SN, among the plurality of network nodes based on receiving a flag from a source master node, MN, and determining the PSCell change procedure was initiated by the other one of the MN and the SN based on absence of receiving the flag from the source MN.
13. The method of any of Embodiments 9 to 12, wherein the indication of which of the plurality of network nodes initiated the PSCell change procedure is received from the source MN in a source node, SN, addition request message.
14. The method of any of Embodiments 9 to 13, wherein the successful PSCell report configuration is sent in a radio resource control, RRC, configuration message.
15. The method of any of Embodiments 9 to 14, wherein the network node is a source master network node, MN, and the method further comprises; generating the successful PSCell report configuration to include an indicator identifying the source master node, MN, that initiated the PSCell change procedure.
16. The method of any of Embodiments 9 to 14, wherein the network node is a source master network node, MN, and the method further comprises: when the successful PSCell report configuration is configured by a source secondary node, SN, the source MN receiving from the source SN an indication that the source SN initiated the PSCell change procedure.
17. The method of any of Embodiments 9 to 16, further comprising:
receiving (330) an indication from the UE that the successful PSCell report is available.
18. The method of any of Embodiments 9 to 17, further comprising: fetching (340) the successful PSCell report from the UE.
19. The method of Embodiment 18, further comprising: distributing (350) the successful PSCell report to another network node based on an indication in the successful PSCell report of which of the plurality of network nodes initiated the PSCell change procedure.
20. The method of Embodiment 19, wherein the successful PSCell report comprises PCell information, and the other network node is selected to receive distribution of the successful PSCell report based on the PCell information.
21. A user equipment, UE, (QQ112A-QQ112D) adapted to:
receive a successful primary secondary cell, PSCell, report configuration containing conditions of a successful PSCell report and indicating which of a plurality of network nodes (QQ110A, QQ110B, QQ108) initiated a PSCell change procedure; and
based on satisfying a condition defined by the successful PSCell report configuration during the PSCell change procedure,
store measurements related to the PSCell change procedure in a successful PSCell report, wherein the measurements are performed according to the successful PSCell report configuration, and
store information in the successful PSCell report indicating which of the plurality of network nodes initiated the PSCell change procedure.
22. The UE (QQ112A-QQ112D) of Embodiment 21, further adapted to perform the method of any of Embodiments 2 to 8.
23. A user equipment, UE, (QQ112A-QQ112D) comprising:
at least one processor (QQ202); and
at least one memory (QQ210) storing instructions executable by the at least one processor to perform operations to:
receive a successful primary secondary cell, PSCell, report configuration containing conditions of a successful PSCell report and indicating which of a plurality of network nodes (QQ110A, QQ110B, QQ108) initiated a PSCell change procedure; and
based on satisfying a condition defined by the successful PSCell report configuration during the PSCell change procedure,
store measurements related to the PSCell change procedure in a successful PSCell report, wherein the measurements are performed according to the successful PSCell report configuration, and
store information in the successful PSCell report indicating which of the plurality of network nodes initiated the PSCell change procedure.
24. The UE (QQ112A-QQ112D) of Embodiment 23, wherein the operations further perform the method of any of Embodiments 2 to 8.
25. A computer program product comprising a non-transitory computer readable medium (QQ210) storing instructions executable by at least one processor of a user equipment, UE, (QQ112A-QQ112D) to perform operations comprising to:
receive a successful primary secondary cell, PSCell, report configuration containing conditions of a successful PSCell report and indicating which of a plurality of network nodes (QQ110A, QQ110B, QQ108) initiated a PSCell change procedure; and
based on satisfying a condition defined by the successful PSCell report configuration during the PSCell change procedure,
store measurements related to the PSCell change procedure in a successful PSCell report, wherein the measurements are performed according to the successful PSCell report configuration, and
store information in the successful PSCell report indicating which of the plurality of network nodes initiated the PSCell change procedure.
26. The computer program product of Embodiment 25, wherein the operations further perform the method of any of Embodiments 2 to 8.
27. A network node (QQ110A, QQ110B, QQ108) among a plurality of network nodes, the network node adapted to:
send to a user equipment, UE, (QQ112A-QQ112D) a successful primary secondary cell, PSCell, report configuration containing conditions for a successful PSCell report and indicating which of the plurality of network nodes initiated a PSCell change procedure.
28. The network node (QQ110A, QQ110B, QQ108) of Embodiment 27, further adapted to perform the method of any of Embodiments 10 to 20.

29. A network node (QQ110A, QQ110B, QQ108) among a plurality of network nodes, the network node comprising:
at least one processor (QQ302); and
at least one memory (QQ304) storing instructions executable by the at least one processor to perform operations to:
send to a user equipment, UE, (QQ112A-QQ112D) a successful primary secondary cell, PSCell, report configuration containing conditions for a successful PSCell report and indicating which of the plurality of network nodes initiated a PSCell change procedure.
30. The network node (QQ110A, QQ110B, QQ108) of Embodiment 29, further

adapted to perform the method of any of Embodiments 10 to 20.
31. A computer program product comprising a non-transitory computer readable medium (QQ304) storing instructions executable by at least one processor of a network node (QQ110A, QQ110B, QQ108) to perform operations comprising to:
send to a user equipment, UE, (QQ112A-QQ112D) a successful primary secondary cell, PSCell, report configuration containing conditions for a successful PSCell report and indicating which of the plurality of network nodes initiated a PSCell change procedure.
32. The computer program product of Embodiment 31, wherein the operations further perform the method of any of Embodiments 10 to 20.

Various terms used herein are listed below with their abbreviations:
CPC Conditional PSCell Change
CGI Cell Global Identity
MN Master Node
PCell Primary Cell
PSCell Primary Secondary Cell Group Cell
RAN Radio Access Network
SCell Secondary Cell
SHR Successful Handover Report
SN Secondary Node
UE User Equipment

1.-34. (canceled)

35. A method performed by a user equipment, UE, comprising:
receiving a configuration for reporting successful primary secondary cell group cell, PSCell, change, said configuration containing conditions for reporting a successful PSCell change;
receiving, with said configuration, information indicating which of a plurality of network nodes that initiated a PSCell change procedure; and
based on satisfying a condition defined by said configuration during the PSCell change procedure, storing the information indicating which of the plurality of network nodes initiated the PSCell change procedure in a successful PSCell change report.

36. The method of claim 35 further comprising:
storing measurements related to the PSCell change procedure in the successful PSCell change report.

37. The method of claim 35, wherein the storing of the information in the successful PSCell change report indicating which of the plurality of network nodes initiated the PSCell change procedure, is performed responsive to determining the PSCell change procedure was initiated by a master node, MN.

38. The method of claim 35, wherein the storing information in the successful PSCell change report indicating which of the plurality of network nodes initiated the PSCell change procedure, comprises storing a flag in the successful PSCell report indicating whether the PSCell change procedure was initiated by a master node, MN, or a secondary node, SN, among the plurality of network nodes.

39. The method of claim 35, further comprising:
based on the PSCell change procedure being initiated by a defined one of a master node, MN, and a secondary node, SN, among the plurality of network nodes, storing a flag in the successful PSCell change report, wherein presence of the flag in the successful PSCell change report indicates the defined one of the MN and SN initiated the PSCell change procedure; and
based on the PSCell change procedure being initiated by the other one of the MN and the SN, not storing the flag in the successful PSCell change report, wherein absence of the flag in the successful PSCell change report indicates the other one of the MN and SN initiated the PSCell change procedure.

40. The method of claim 35, wherein the storing of the information in the successful PSCell change report indicating which of the plurality of network nodes initiated the PSCell change procedure, comprises:
responsive to determining the PSCell change procedure was initiated by a master node, MN, storing the source PSCell information and the target PSCell information without storing the source PCell information in the successful PSCell change report.

41. The method of claim 35, wherein the storing of the information in the successful PSCell change report indicating which of the plurality of network nodes initiated the PSCell change procedure, comprises:
responsive to determining the PSCell change procedure was initiated by a master node, MN, or a secondary node, SN, storing the source PSCell information and the target PSCell information without storing the source PCell information in the successful PSCell change report.

42. A method performed by a network node among a plurality of network nodes, the method comprising:
sending to a user equipment, UE, a configuration for reporting successful primary secondary cell, PSCell, change, said configuration containing conditions for reporting a successful PSCell change; and sending, with said configuration, information indicating which of a plurality of network nodes that initiated a PSCell change procedure.

43. The method of claim 42, wherein the network node is a target secondary node, SN, and the method further comprises:
receiving from a source master node, MN, an indication of which of the plurality of network nodes initiated the PSCell change procedure; and
generating the successful PSCell change report configuration to include the indication of which of the plurality of network nodes initiated the PSCell change procedure.

44. The method of claim 42, wherein the network node is a source master network node, MN, and the method further comprises:
generating the successful PSCell change report configuration to include an indicator identifying the source master node, MN, that initiated the PSCell change procedure.

45. The method of claim 42, wherein the network node is a source master network node, MN, and the method further comprises:
when the successful PSCell change report configuration is configured by a source secondary node, SN, the source MN receiving from the source SN an indication that the source SN initiated the PSCell change procedure.

46. A user equipment, UE, adapted to:
receive a configuration for reporting a successful primary secondary cell group cell, PSCell, change, said configuration containing conditions for reporting a successful PSCell change; receive, with said configuration, information indicating which of a plurality of network nodes that initiated a PSCell change procedure; and
based on satisfying a condition defined by said configuration during the PSCell change procedure, store the information indicating which of a plurality of network nodes initiated the PSCell change procedure in a successful PSCell change report.

47. The UE of claim 46, further adapted to perform the method of receiving a configuration for reporting successful primary secondary cell group cell, PSCell, change, said configuration containing conditions for reporting a successful PSCell change; receiving, with said configuration, information indicating which of a plurality of network nodes that initiated a PSCell change procedure;
based on satisfying a condition defined by said configuration during the PSCell change procedure, storing the information indicating which of the plurality of network nodes initiated the PSCell change procedure in a successful PSCell change report; and
storing measurements related to the PSCell change procedure in the successful PSCell change report.

48. A network node among a plurality of network nodes, the network node adapted to:
send to a user equipment, UE, a configuration for reporting successful primary secondary cell group cell, PSCell, change, said configuration containing conditions for reporting a successful PSCell change; and
send, with said configuration, information indicating which of a plurality of network nodes that initiated a PSCell change procedure.

49. The network node of claim 48, further adapted to perform the method of sending to a user equipment, UE, a configuration for reporting successful primary secondary cell, PSCell, change, said configuration containing conditions for reporting a successful PSCell change; and sending, with said configuration, information indicating which of a plurality of network nodes that initiated a PSCell change procedure,
wherein the network node is a target secondary node, SN, and the method further comprises:
receiving from a source master node, MN, an indication of which of the plurality of network nodes initiated the PSCell change procedure; and
generating the successful PSCell change report configuration to include the indication of which of the plurality of network nodes initiated the PSCell change procedure.
